(19) United States
(12) Patent Application Publication
(10) Pub. No.: US 2020/0299201 A1
(43) Pub. Date: Sep. 24, 2020

(54) METHOD FOR PRODUCING CERAMIC HONEYCOMB STRUCTURE

(71) Applicant: NGK INSULATORS, LTD., Nagoya-Shi (JP)

(72) Inventors: Yukari KOMAI, Nagoya-Shi (JP); Shungo NAGAI, Nagoya-Shi (JP)

(73) Assignee: NGK INSULATORS, LTD., Nagoya-Shi (JP)

(21) Appl. No.: 16/744,538

(22) Filed: Jan. 16, 2020

(30) Foreign Application Priority Data
Mar. 19, 2019 (JP) 2019-051984

(51) Int. Cl. C04B 38/00; C04B 35/195

(52) U.S. Cl. CPC C04B 38/0012; C04B 2235/3481; C04B 35/195; C04B 38/0009

(57) ABSTRACT

A method for producing a ceramic honeycomb structure including: plugging ends of cells on one of a first end face side and a second end face side in each of the cells of a ceramic honeycomb formed body that includes partition walls defining the cells extending from the first end face to the second end face; placing the ceramic honeycomb formed body on a shelf board with the first end face facing downward; arranging at least one lid member on the second end face of the ceramic honeycomb formed body so as to completely cover the second end face; and placing the ceramic honeycomb formed body together with the shelf board and the lid member in a firing furnace and firing the ceramic honeycomb formed body.

### FIELD OF THE INVENTION

The present invention relates to a method for producing a ceramic honeycomb structure.

### BACKGROUND OF THE INVENTION

A honeycomb structure made of ceramics (hereinafter referred to as a “ceramic honeycomb structure”) is widely used for a wide variety of applications such as catalyst supports for purifying automobile exhaust gases, gasoline particulate removal filters (GPFs), diesel particulate removal filter (DPFs), heat storage bodies for combustion devices, and the like.

The ceramic honeycomb structure has a structure including partition walls that define a plurality of cells extending from a first end face to a second end face. More particularly, in the ceramic honeycomb structure used for GPFs, DPFs, or the like, ends of the cells on one of the first end face side or the second end face side in each of the cells are plugged, and the partition walls functions as a filter.

The ceramic honeycomb structure having the above structure is formed by extruding a forming material (a green body) into a honeycomb shape to produce a ceramic honeycomb formed body, performing processing such as cutting and drying, and then filling predetermined ends of the cells with a forming slurry, drying and firing it (for example, see Patent Document 1).

### CITATION LIST

### Patent Literature

Patent Document 1: Japanese Patent Application Publication No. 2015-178436 A

### SUMMARY OF THE INVENTION

The present invention provides a method for producing at least one ceramic honeycomb structure, the method comprising:

a plugging step of plugging ends of cells on one of a first end face side and a second end face side in each of the cells of at least one ceramic honeycomb formed body, the at least one ceramic honeycomb formed body comprising partition walls that define the cells extending from the first end face to the second end face;

a shelf board placing step of placing the at least one ceramic honeycomb formed body on a shelf board with the first end face facing downward;

a lid arranging step of arranging at least one lid member on the second end face of the at least one ceramic honeycomb formed body so as to completely cover the second end face; and a firing step of placing the at least one ceramic honeycomb formed body together with the shelf board and the lid member in a firing furnace and firing the at least one ceramic honeycomb formed body.

According to the present invention, it is possible to provide a method for producing a ceramic honeycomb structure, which can suppress generation of internal defects in partition walls around plugged portions.

### BRIEF DESCRIPTION OF THE DRAWINGS

FIG. 1 is a cross-sectional view parallel to an extending direction of cells of a plugged ceramic honeycomb formed body.

FIG. 2 is a front view of a first end face of a plugged ceramic honeycomb formed body.

FIGS. 3(a) and 3(b) are views for explaining a shelf board placing step and a lid arranging step.

FIG. 4 explains a mechanism of generation of internal defects of partition walls.

### DETAILED DESCRIPTION OF THE INVENTION

In recent years, for a ceramic honeycomb structure having plugged portions, internal defects have been often found in partition walls around the plugged portions during a defect inspection using a laser smoke method or the like. The internal defects in the partition walls may lead to a decrease in a filter function. Therefore, there has been a need for development of a method for solving the problem.

The present invention has been made in order to solve the above problems. An object of the present invention is to provide a method for producing a ceramic honeycomb structure, which can suppress generation of internal defects in partition walls around plugged portions.

As a result of intensive studies on the internal defects in the partition walls around the plugged portions, the present inventors have found that the internal defects are generated during firing, starting from foreign matters that enter the cells during a step after a plugging step and remain on the plugged portions. Based on the finding, the present inventors have found that after plugging, a lid member is arranged on the end face and performing the firing, so that intrusion of the foreign matters into the cells can be prevented and the above problems can be solved, and they have completed the present invention.

Hereinafter, embodiments according to the present invention will be specifically described with reference to the drawings. It is to understand that the present invention is not limited to the following embodiments, and various modifications and improvements, which will be within the scope of the present invention, may be made based on ordinary knowledge of a person skilled in the art, without departing from the spirit of the present invention.

A method for producing a ceramic honeycomb structure according to an embodiment of the present invention includes a plugging step, a shelf board placing step, a lid arranging step, and a firing step. The order of the respective steps is not particularly limited, with the exception that the plugging step is previously carried out and the firing step is finally carried out. That is, after carrying out the shelf board placing step immediately after the plugging step, the lid arranging step and the firing step may be sequentially carried out, or after carrying out the lid arranging step immediately after the plugging step, the shelf board placing step and the firing step may be sequentially carried out.

The plugging step plugs ends of cells on one of a first end face side or a second end face side in each of the cells of a ceramic honeycomb formed body including partition walls that define the cells extending from the first end face to the second end face.

The ceramic honeycomb formed body to be plugged may be fired or not fired, but it is preferably fired because only one firing step is required for the production of the ceramic honeycomb structure. That is, it is preferable that the ceramic honeycomb formed body to be plugged is in a state where cutting and drying have been carried out after extrusion molding.

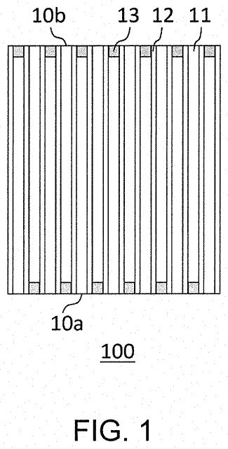

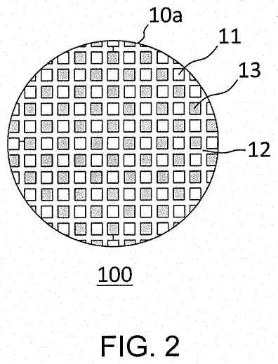

Here, FIG. 1 shows a cross-sectional view parallel to a direction where the cells of the plugged ceramic honeycomb formed body extend. FIG. 2 is a front view of the first end face of the formed ceramic honeycomb body. As shown in FIG. 1, the ceramic honeycomb formed body 100 includes partition walls 12 that define a plurality of cells 11 extending from a first end face 10a to a second end face 10b, and has plugged portions 13 on ends of the cells 11 on either the first end face 10a side or the second end face 10b side. The plugged portions 13 are preferably formed alternately (in a checkered pattern) at the ends of the adjacent cells 11 on the first end face 10a and the second end face 10b. That is, it is preferable that one cell 11 has an opening at one end and a plugged portion 13 formed at the other end, and other cell 11 adjacent to that cell 11 has a plugged portion 13 formed at one end and an opening at the other end.

The ceramic honeycomb formed body 100 is produced by forming a green body containing a ceramic raw material, a binder, a surfactant, a pore former, water, and the like.

The ceramic raw material includes, but not particularly limited to, silicon carbide (SiC), silicon-silicon carbide (Si—SiC) composite materials, cordierite forming raw materials, cordierite (Cd), mullite, alumina, titania, spinel, silicon carbide (SiC)-cordierite (Cd) based composite materials, lithium aluminum silicate, aluminum titanate, and iron-chromium-aluminum alloys. These can be used alone or in combination of two or more. Among them, the cordierite forming raw materials are preferable.

As used herein, the cordierite forming raw material refers to a ceramic raw material formulated so as to have a chemical composition containing from 42 to 56% by mass of silica, from 30 to 45% by mass of alumina, and from 12 to 16% by mass of magnesia, which is converted into cordierite after firing. On the other hand, when the silicon-silicon carbide composite material is used, a mixture of silicon carbide powder and metallic silicon powder is defined as the ceramic raw material.

The content of the ceramic raw material is preferably from 40 to 90% by mass based on the entire forming material (green body), although not particularly limited thereto.

Examples of the binder include, but not limited to, methyl cellulose, hydroxypropoxyl cellulose, hydroxyethyl cellulose, carboxymethyl cellulose, polyvinyl alcohol, and the like. These can be used alone or in combination of two or more. Among them, it is preferable to use methyl cellulose in combination with hydroxypropoxyl cellulose.

The content of the binder is preferably from 3 to 15% by mass based on the entire forming material (green body), although not particularly limited thereto.

Examples of the surfactant include, but not particularly limited to, ethylene glycol, dextrin, fatty acid soaps, and polyalcohols. These can be used alone or in combination of two or more.

The content of the surfactant is preferably 5% by mass or less based on the entire forming material (green body), although not particularly limited thereto.

The pore former is not particularly limited as long as it forms pores after firing. Examples of the pore former include starch, foamed resins, water-absorbing resins, silica gel, and carbon. These can be used alone or in combination of two or more.

The content of the pore former is preferably 15% by mass or less based on the entire forming material (green body), although not particularly limited thereto.

The content of water is preferably from 7 to 45% by mass based on the entire forming material (green body), although not particularly limited thereto.

The green body can be obtained by mixing and kneading the above raw materials. The method of mixing and kneading the raw materials is not particularly limited, and it can be carried out by a method known in the art. For example, the mixing and kneading of the raw materials can be carried out using a kneader, a vacuum kneader, or the like.

The method of forming the green body is not particularly limited, and it can be carried out by a method known in the art, for example, extrusion molding.

The partition walls 12 of the ceramic honeycomb formed body 100 may be preferably formed of at least one ceramic selected from the group consisting of cordierite, silicon carbide, silicon-silicon carbide based composite materials, silicon nitride, mullite, alumina, silicon carbide-cordierite based composite materials and aluminum titanate after firing, although not particularly limited thereto. By forming the partition walls 12 from these ceramics, the strength and heat resistance of the ceramic honeycomb structure can be improved.

A thickness of each partition wall 12 (a thickness of each partition wall 12 in a cross section perpendicular to a direction where the cells 11 extend) of the ceramic honeycomb formed body 100 is such that the thickness of each partition wall 12 of the ceramic honeycomb structure after firing (the thickness of each partition wall 12 in a cross section perpendicular to the direction where the cells 11 extend) is preferably from 0.10 to 0.45 mm, and more preferably from 0.10 to 0.30 mm, and still more preferably from 0.12 to 0.20 mm, although not particularly limited thereto. In order to control the thickness of the partition walls 12 after firing within the above range, the thickness of each partition wall 12 of the ceramic honeycomb formed body 100 may be from 0.10 to 0.50 mm. The thickness of each partition wall 12 after firing of 0.10 mm or more can ensure the strength of the ceramic honeycomb structure. Further, the thickness of each partition wall 12 after firing of 0.45 mm or less can suppress an increase in pressure loss. Therefore, for example, when the ceramic honeycomb structure is used for GPFs, DPFs, or the like, a decrease in engine output can be suppressed.

It should be noted that the thickness of each partition wall after firing can be measured using an image analyzer (for example, product name “NEXIV, VMR-1515” from Nikon Corporation) in a cross section perpendicular to the direction where the cells 11 of the ceramic honeycomb structure extend.

The plugging method is not particularly limited, and a method known in the art can be used. More particularly, the end faces of the ceramic honeycomb formed body 100 are immersed in a plugging portion forming slurry while masking the ends (openings) of the cells 11 where plugging is not carried out, thereby filling predetermined ends with the plugging portion forming slurry. The filled plugging portion forming slurry is then dried to form plugged portions 13 at the predetermined ends of the cells 11.

As the plugging portion forming slurry, a slurry having the same composition as that of the green body used for production of the ceramic honeycomb formed body 100 can be used, although not particularly limited thereto.

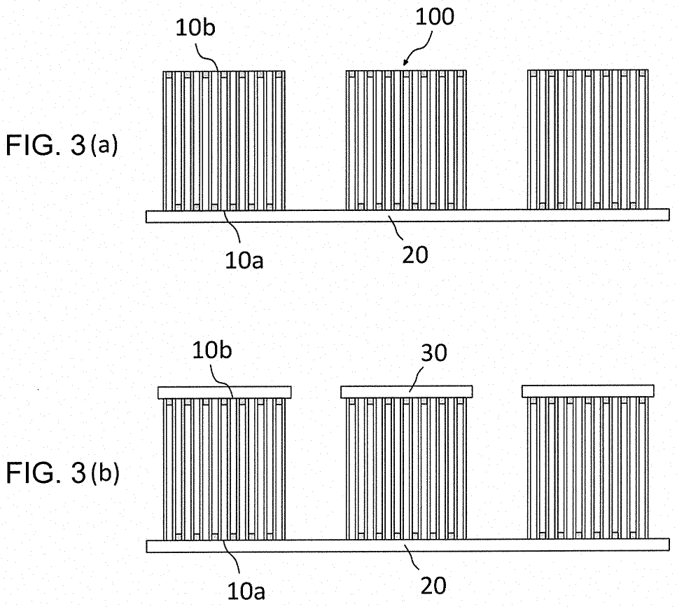

In the shelf board placing step, as shown in FIG. 3(a), the ceramic honeycomb formed body 100 is placed on a shelf board 20 with the first end face 10a facing downward.

The shelf board 20 is one of members for firing (a kiln tool), and is a member for placing a plurality of ceramic honeycomb formed bodies 100 on the shelf board 20.

The ceramic honeycomb formed body 100 may be directly placed on the shelf board 20. However, in order to prevent the ceramic honeycomb formed body 100 from adhering to the shelf board 20, the ceramic honeycomb formed body 100 may be indirectly placed via other member (for example, a floor board).

The other member is not particularly limited. For example, a member called “a firing setter” can be used. Example of the firing setter include a disk-shaped member obtained by cutting a ceramic honeycomb structure obtained by firing the ceramic honeycomb formed body 100 into a predetermined thickness, and a member obtained by pressing a ceramic material into a disk shape and firing it.

In the lid arranging step, as shown in FIG. 3(b), a lid member 30 is arranged on the second end face 10b of the ceramic honeycomb formed body 100 so as to completely cover the second end face 10b.

As used herein, the lid member 30 means a member capable of closing the openings of the cells 11 on the second end face 10b.

The lid member 30 is preferably formed of an inorganic material. The use of the lid member 30 formed of the inorganic material can allow the lid member to sufficiently withstanding a firing temperature in the firing step.

The lid member 30 is preferably formed of at least one ceramic selected from the group consisting of cordierite, silicon carbide, silicon-silicon carbide based composite materials, silicon nitride, mullite, alumina, silicon carbide-cordierite based composite materials and aluminum titanate, among inorganic materials. By selecting such a material, the material of the lid member is the same as that of the ceramic honeycomb formed body 100, thereby allowing reduction of a risk that foreign matters causing internal defects of the partition walls 12 enter the cells 11.

The shape of the lid member 30 may be a shape that can completely cover the second end face 10b of one ceramic honeycomb formed body 100 or a shape that can completely cover the second end faces 10b of a plurality of ceramic honeycomb formed bodies 100, although not particularly limited thereto.

As a specific example of the lid member 30, for example, the above firing setter can be used. However, when the disc-shaped member obtained by cutting the ceramic honeycomb structure obtained by firing the ceramic honeycomb formed body 100 into a predetermined thickness is used, all the cells 11 should be plugged. This is because, when all the cells 11 are not plugged, the openings of the cells 11 on the second end face 10b cannot be closed, so that a function as the lid member 30 is not achieved.

Any one of the shelf board mounting step and the lid arranging step may be previously carried out, but it is preferable to carried out the lid arranging step first, i.e., to carried out the lid arranging step immediately after the plugging step. This is because the foreign matters may enter the cells 11 immediately after the plugging step, so that the lid arranging step is carried out as early as possible, whereby it is possible to prevent the foreign matters from entering the cells 11.

In the firing step, the ceramic honeycomb formed body 100 is placed in a firing furnace together with the shelf board 20 and the lid member 30 and fired.

In the firing furnace, various deposits adhere to a furnace wall as the furnace is used, and the deposits may fall as foreign matters during firing. Further, as the firing furnace is aged, foreign matters derived from the firing furnace may fall.

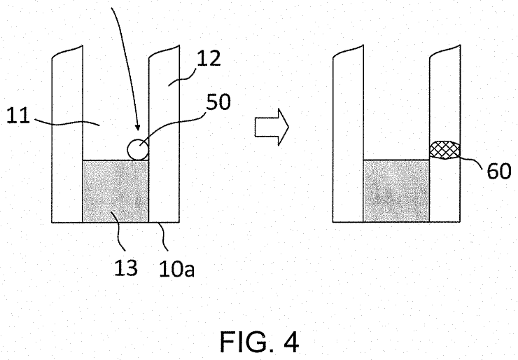

Referring now to FIG. 4, it shows views for explaining a mechanism of generation of an internal defect of the partition wall 12 starting from the above foreign matter. As shown in FIG. 4, when the foreign matter 50 enters the cell 11 from the second end face 10b and remains on the plugged portion 13, an internal defect 60 is generated in the partition wall 12 starting from the foreign matter 50 during firing.

In the method for producing the ceramic honeycomb structure according to an embodiment of the present invention, the lid member 30 is placed on the second end face 10b of the ceramic honeycomb formed body 100 in the lid arranging step, so that the foreign matters 50 do not infiltrate in the cells 11, thereby allowing prevention of the internal defects 60 from being generated in the partition walls 12 starting from the foreign matters 50 during firing.

The firing conditions in the firing step may be appropriately adjusted depending on the material of the ceramic honeycomb formed body 100, and are not particularly limited.

The method for producing the ceramic honeycomb structure according to an embodiment of the present invention may further include, in addition to the above steps, a defect inspection step of carrying out a defect inspection by a laser smoke method after firing the ceramic honeycomb formed body 100. By carrying out the defect inspection step, a ceramic honeycomb structure in which the internal defect(s) 60 is/are present on the partition wall(s) 12 can be eliminated, so that the quality of the ceramic honeycomb structure can be improved.

As used herein, the defect inspection by the laser smoke method refers to an inspection method in which fine particles (smoke or water) generated by burning incense materials are fed under pressure from one end face of the ceramic honeycomb structure (the fired ceramic honeycomb formed body 100), and also irradiating the other end face with light to visualize the fine particles flowing out from the end face. For example, the partition wall 12 having the internal defect 60 has lower permeation resistance than that of the partition wall 12 having no internal defect 60, so that more fine particles will flow out from the end face. The irradiation of this end face with light changes luminance of light depending on the number of the fine particles. Therefore, the luminance of the light is be detected to estimate the number of the fine particles, and the area where more fine particles flow out can be evaluated as having the internal defect in the partition wall 12.

In addition, the defect inspection method by the laser smoke method is known from Japanese Patent No. 3839177 B, Japanese Patent No. 3904933 B, and Japanese Patent No. 4913797 B, and these methods may be used.

### EXAMPLES

Hereinafter, the present invention will be more specifically described with reference to Examples, but the present invention is not limited to these Examples.

### (Preparation of Ceramic Honeycomb Formed Body)

As the ceramic raw material, a ceramic raw material was prepared by mixing 51% by mass of silica (SiO₂), 36% by mass of alumina (Al₂O₃), and 13% by mass of magnesia (MgO). To the ceramic raw material were added methyl cellulose as a binder, a water-absorbing resin as a pore former, and also water to prepare a forming raw material. The resulting forming raw material was mixed and kneaded to obtain a green body. The resulting green body was then extrusion-molded using an extruder, and cut and dried. The ceramic honeycomb formed body was adjusted to have a diameter of 118 mm, an axial length of 108 mm, and a partition wall thickness of 0.20 mm after firing.

### Example 1

A ceramic honeycomb structure was producing by sequentially carrying out the following steps.

### (Plugging Step)

One end face of the ceramic honeycomb formed body obtained above was masked in a checkered pattern. The masked end surface was immersed in a plugging portion forming slurry to fill the unmasked ends with the plugging portion forming slurry, and dried to form plugged portions. Plugged portions were also formed on the other end face in the same procedure. In addition, as the plugging portion forming slurry, a slurry having the same composition as that of the green body used for producing the ceramic honeycomb formed body was used.

### (Lid Arranging Step)

Used as the lid member was a disk-shaped member obtained by cutting the ceramic honeycomb structure resulting from firing of the above ceramic honeycomb formed body into to a predetermined thickness (all the cells were plugged).

For the ceramic honeycomb formed body obtained in the plugging step, the lid member was arranged on the upper end face such that the extending direction of the cells was directed to the vertical direction.

### (Shelf Board Placing Step)

A disk-shaped member obtained by cutting the ceramic honeycomb structure obtained by firing the above ceramic honeycomb formed body into a predetermined thickness (all the cells were not plugged) was arranged on the shelf board on which the ceramic honeycomb formed body having the lid member disposed on the upper end surface was placed.

### (Firing Step)

The ceramic honeycomb formed body placed on the shelf board was placed in a firing furnace together with the shelf board and the lid member to fire it.

### (Defect Inspection Step)

The ceramic honeycomb formed body after firing (the ceramic honeycomb structure) was inspected for defects by the laser smoke method. The laser smoke method was carried out by pressurizing smoke of a stick of incense as fine particles (an average particle size of from 1 to 10 μm) with a pump (from 1 to 30 Pa), and feeding the fine particles to the ceramic honeycomb structure, and also irradiating 3 mm above the end face with slit light by a semiconductor laser, and taking an image with a CCD camera. Inspection results were evaluated by analyzing the resulting image, and the number of defective products was determined.

### Comparative Example 1

A ceramic honeycomb structure was produced in the same procedure as that of Example 1, with the exception that the lid arranging step was not carried out.

Table 1 shows the inspection results in the defect inspection step of the ceramic honeycomb structures obtained in Example and Comparative Example as described above.

TABLE 1

| | | Number of | Number of | Defect |
|---|---|---|---|---|
| | Number of | Passed | Defective | Rate |
| | Inspections | Product | Products | (%) |
| Example 1 | 40 | 40 | 0 | 0 |
| Comparative Example 1 | 715 | 681 | 34 | 4.8 |

As shown in Table 1, in Example 1 where the lid arranging step was carried out, no defective product was generated, and the defect rate was significantly improved as compared with Comparative Example 1 where the lid arranging step was not carried out.

As can be seen from the above results, according to the present invention, it is possible to provide a method for producing a ceramic honeycomb structure, which can suppress generation of internal defects in partition walls around plugged portions.

### DESCRIPTION OF REFERENCE NUMERALS

10a first end face
10b second end face
11 cell
12 partition wall
13 plugged portion
20 shelf board
30 lid member
50 foreign matter
60 internal defect
100 ceramic honeycomb formed body

1. A method for producing at least one ceramic honeycomb structure, the method comprising:
a plugging step of plugging ends of cells on one of a first end face side and a second end face side in each of the cells of at least one ceramic honeycomb formed body, the at least one ceramic honeycomb formed body comprising partition walls that define the cells extending from the first end face to the second end face;
a shelf board placing step of placing the at least one ceramic honeycomb formed body on a shelf board with the first end face facing downward;
a lid arranging step of arranging at least one lid member on the second end face of the at least one ceramic honeycomb formed body so as to completely cover the second end face; and
a firing step of placing the at least one ceramic honeycomb formed body together with the shelf board and the lid member in a firing furnace and firing the at least one ceramic honeycomb formed body.

2. The method for producing at least one ceramic honeycomb structure according to claim 1, wherein in the shelf board placing step, a firing setter is arranged between the shelf board and the first end face of the ceramic honeycomb formed body.

3. The method for producing at least one ceramic honeycomb structure according to claim 1, wherein the lid member is formed of an inorganic material.

4. The method for producing at least one ceramic honeycomb structure according to claim 1, wherein the lid member is a firing setter.

5. The method for producing at least one ceramic honeycomb structure according to claim 1, wherein the lid arranging step is carried out immediately after the plugging step.

6. The method for producing at least one ceramic honeycomb structure according to claim 1, further comprising a defect inspection step of carrying out a defect inspection by a laser smoke method after firing the ceramic honeycomb formed body.

7. The method for producing at least one ceramic honeycomb structure according to claim 1, wherein after firing, the partition walls are formed of at least one ceramic selected from the group consisting of cordierite, silicon carbide, silicon-silicon carbide based composite materials, silicon nitride, mullite, alumina, silicon carbide-cordierite based composite materials and aluminum titanate.

8. The method for producing at least one ceramic honeycomb structure according to claim 1, wherein each of the partition walls after firing has a thickness of from 0.10 to 0.45 mm.
